(19) United States
(12) Patent Application Publication
(10) Pub. No.: US 2010/0248059 A1
(43) Pub. Date: Sep. 30, 2010

(54) FUEL CELL UNIT AND FUEL CELL STACK

(75) Inventors: Shinnosuke Koji, Kawasaki-shi (JP); Satoshi Mogi, Yamato-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/740,882

(22) PCT Filed: Jan. 27, 2009
(86) PCT No.: PCT/JP2009/051679

§ 371 Date: Apr. 30, 2010

(30) Foreign Application Priority Data
Jan. 28, 2008 (JP) 2008-016455

(51) Int. Cl. H01M 8/04

(52) U.S. Cl. 429/443

(57) ABSTRACT

There is provided a fuel cell unit and a fuel cell stack including a flow rate controlling member provided in an anode flow path on the side of an exhaust flow path so as to be in contact with an anode gas diffusion layer wherein the flow rate controlling member generates pressure difference between an upstream side of the fuel flow path from a portion at which the flow rate controlling member is provided and a downstream side of the fuel flow path from the portion at which the flow rate controlling member is provided. The fuel cell unit and the fuel cell stack can uniformly supply a fuel and can prevent backflow of the fuel containing an impurity gas from a downstream side.

### TECHNICAL FIELD

The present invention relates to a fuel cell unit and a fuel cell stack.

### BACKGROUND ART

A polymer electrolyte fuel cell unit includes a polymer electrolyte membrane having proton conductivity and a pair of electrodes provided on both surfaces thereof.

The electrodes include a catalyst layer containing a platinum or platinum group metal and a gas diffusion layer which is formed on an outer surface of the catalyst layer and supplies gas and collects current.

An integration of the pair of electrodes and the polymer electrolyte membrane is referred to as a membrane electrode assembly (MEA). Electric power is generated by supplying a fuel (hydrogen) to one of the electrodes and an oxidant (oxygen) to the other of the electrodes.

A theoretical voltage of a fuel cell unit is about 1.23 V. In actual operation, a fuel cell unit is generally used with an output voltage of about 0.7 V.

Therefore, when a higher electromotive voltage is necessary, multiple fuel cell units are stacked with each other and the fuel cell units are electrically connected to each other in series to be used. Such a structure is referred to as a fuel cell stack.

A fuel cell as used herein refers to both a fuel cell unit and a fuel cell stack.

In order to make a fuel cell stack generate electric power efficiently, it is necessary to make individual fuel cell units forming the fuel cell stack generate electric power efficiently.

Therefore, design and control are necessary such that temperature conditions of the respective fuel cell units and supply of a fuel and an oxidant to the respective fuel cell units are uniform.

Generally, a fuel flow path and an oxidant flow path in a fuel cell stack are formed in parallel with the fuel cell units, and the fuel and the oxidant are distributed to the respective fuel cell units in parallel. Japanese Patent Application Laid-Open No. H08-213044 discloses a technology in which, in such a fuel cell, a rectifying member formed of a porous body having a three-dimensional network is provided at a gas port of the fuel cell stack to make uniform the supply of the fuel and the oxidant to the respective fuel cell units.

Meanwhile, a so-called dead-end fuel cell is known in which, in order to make a system including a fuel cell smaller and to improve the use efficiency of the fuel, the fuel flow path is closed on a downstream side of the fuel flow path of the fuel cell stack.

While a dead-end fuel cell can make a system smaller and can improve the use efficiency of the fuel, it has a problem that, due to accumulation of an impurity gas such as nitrogen or water vapor, the performance of the fuel cell is reduced.

Accordingly, in order not to allow an impurity gas to accumulate in the respective fuel cell units, a configuration is proposed in which electric power is generated with a small amount of the fuel containing an impurity gas steadily flowing from a downstream side of the fuel cell stack.

Japanese Patent Application Laid-Open No. 2002-008691 discloses a fuel cell system in which, by opening and closing an exhaust valve of a dead-end fuel cell according to the amount of hydrogen consumed in the fuel cell, the amount of unreacted hydrogen exhausted together with an impurity gas is reduced.

On the other hand, Japanese Patent Application Laid-Open No. 2007-227365 discloses a fuel cell device which realizes uniform supply of a fuel gas and efficient exhaust of an impurity gas by designing flow path resistances of a supply side flow path, a branch flow path corresponding to an electric power generating portion, and an exhaust side flow path of a fuel cell stack.

The technology disclosed in Japanese Patent Application Laid-Open No. H08-213044 is effective in the configuration in which a fuel is made to flow steadily, but in a dead-end fuel cell and in a system in which the flow rate of a fuel is tightly restricted downstream of a fuel flow path of a fuel cell stack, it is difficult to uniformly supply the fuel to the respective fuel cell units.

This is because, due to problems that the flow path resistances of the respective fuel cell units are nonuniform within the respective fuel cell units and vary among the respective fuel cell units, and that pressure loss is caused at an electric power generating portion due to consumption of the fuel by electric power generation, and the like, backflow and accumulation from the downstream side are caused.

The fuel cell system disclosed in Japanese Patent Application Laid-Open No. 2002-008691 is a unit for temporarily restoring the performance lowered due to accumulation of an impurity gas by means of opening and closing the exhaust valve, and the accumulation of the impurity gas itself cannot be suppressed.

Further, because the flow path resistances of the respective fuel cell units are nonuniform as described above, there arises a problem that accumulation of an impurity gas is caused in a specific fuel cell unit and the performance is considerably lowered.

This is thought to be because backflow of a fuel gas containing an impurity gas from an exhaust flow path of a fuel cell stack concentrates on a specific fuel cell unit.

Therefore, there arises a problem that a fuel gas containing an impurity gas has to be exhausted by frequently opening and closing the exhaust valve, and the use efficiency of hydrogen is reduced.

The fuel cell device disclosed in Japanese Patent Application Laid-Open No. 2007-227365 can realize uniform supply of a fuel gas and efficient exhaust of an impurity gas, but there arises a problem that, when the variation in flow path resistance among the respective fuel cell units is large due to manufacturing error or the flow path resistance changes by water generated by electric power generation, countermeasures thereagainst are not sufficient. In particular, countermeasures are not sufficient against clogging of a flow path due to water droplets generated by condensation in the fuel flow path caused by electric power generation for a long time. Therefore, countermeasures are desired against the variation in flow path resistance among the respective fuel cell units and against the clogging of a flow path due to water generated by electric power generation for a long time.

### DISCLOSURE OF THE INVENTION

The present invention is directed to a fuel cell unit and a fuel cell stack which can, even when flow path resistances of the respective fuel cell units vary, uniformly supply a fuel and can effectively prevent backflow of the fuel containing an impurity gas from a downstream side thereof.

The present invention is also directed to a fuel cell unit and a fuel cell stack which can suppress clogging of a flow path due to water generated by electric power generation for a long time.

According to the present invention, there is provided a fuel cell unit including:

an anode gas diffusion layer and an anode flow path on a side to which a fuel gas is introduced;

a supply flow path having a supply port of the fuel gas, the supply flow path being connected upstream of the anode flow path to which the fuel gas is introduced;

an exhaust flow path having an exhaust port of the fuel gas, the exhaust flow path being connected downstream of the anode flow path to which the fuel gas is introduced, the supply flow path, the anode flow path, and the exhaust flow path forming a fuel flow path; and

a first flow rate controlling member provided in the fuel flow path on a side of the exhaust flow path to be in contact with the anode gas diffusion layer,

wherein, by the first flow rate controlling member, pressure difference is generated between an upstream side of the fuel flow path from a portion at which the first flow rate controlling member is provided and a downstream side of the fuel flow path from the portion at which the first flow rate controlling member is provided.

Further, in the fuel cell unit according to the present invention, a flow rate controlled by the first flow rate controlling member is larger than an entry flow rate of an impurity gas containing nitrogen which enters the anode flow path.

Further, in the fuel cell unit according to the present invention, when electric power is not generated, the pressure difference of the fuel gas generated by the first flow rate controlling member is larger than a pressure loss caused by electric power generation in the anode flow path.

Further, in the fuel cell unit according to the present invention, the first flow rate controlling member includes a porous body.

Further, in the fuel cell unit according to the present invention, the anode flow path is filled with the anode gas diffusion layer.

Further, the fuel cell unit according to the present invention further includes a second flow rate controlling member provided downstream of the exhaust port, for suppressing an exhaust amount of the fuel gas exhausted from the exhaust port.

Further, the fuel cell unit according to the present invention further includes a fuel gas consuming mechanism provided downstream of the exhaust port, for consuming the fuel gas exhausted from the exhaust port.

Further, the fuel cell unit according to the present invention further includes a second flow rate controlling member provided between the exhaust port and the fuel gas consuming mechanism, for suppressing an exhaust amount of the fuel gas exhausted from the exhaust port.

According to the present invention, there is provided a fuel cell stack including:

a plurality of the above-mentioned fuel cell units stacked with each other;

a supply flow path having a supply port of a fuel gas, the supply flow path being connected upstream of an anode flow path of each of the fuel cell units, to which the fuel gas is introduced; and

an exhaust flow path having an exhaust port of the fuel gas, the exhaust flow path being connected downstream of the anode flow path of each of the fuel cell units, to which the fuel gas is introduced, the supply flow path, the anode flow path, and the exhaust flow path forming a fuel flow path.

Further, the fuel cell stack according to the present invention further includes a second flow rate controlling member provided downstream of the exhaust port, for suppressing an exhaust amount of the fuel gas exhausted from the exhaust port.

Further, the fuel cell stack according to the present invention further includes a fuel gas consuming mechanism provided downstream of the exhaust port, for consuming the fuel gas exhausted from the exhaust port.

Further, the fuel cell stack according to the present invention further includes a second flow rate controlling member provided between the exhaust port and the fuel gas consuming mechanism, for suppressing an exhaust amount of the fuel gas exhausted from the exhaust port.

According to the present invention, by the first flow rate controlling member provided in the fuel flow path on the exhaust flow path side, large pressure difference can be generated between an upstream side of the fuel flow path from a portion at which the first flow rate controlling member is provided and a downstream side of the fuel flow path from the portion at which the first flow rate controlling member is provided.

This allows uniform supply of a fuel from the supply flow path to the anode flow path including an electric power generating portion of the fuel cell, and backflow of the fuel gas containing the impurity gas from the exhaust flow path can be prevented.

Further, by providing the flow rate controlling member so as to be in contact with the anode gas diffusion layer, clogging of the flow path due to condensation of moisture generated in association with the electric power generating reaction of the fuel cell and diffused in the anode flow path can be prevented.

Clogging of the flow path between the anode flow path and the flow rate controlling member inhibits exhaust of the impurity gas which enters the anode flow path, and thus, reduces the performance of the fuel cell.

Providing the flow rate controlling member so as to be in contact with the anode gas diffusion layer allows the flow rate controlling member to be placed under temperature conditions which are equivalent to or near to those of the electric power generating portion, and thus, condensation can be prevented. As a result, the fuel cell can be driven stably.

With such a configuration, even in a dead-end fuel cell and in a system in which the flow rate of a fuel is tightly restricted downstream of the fuel flow path of the fuel cell stack, the fuel is uniformly supplied to the respective fuel cell units of the fuel cell and the fuel cell stack, and backflow and accumulation of the impurity gas from the downstream side can be prevented.

Further, the flow path between the anode flow path and the first flow rate controlling member is not clogged by condensation, and hence the fuel cell can be driven stably.

Further, the fuel cell stack in which the first flow rate controlling member is provided so as to be in contact with the anode gas diffusion layer of each of the fuel cell units may be adapted to have a flow rate adjusting mechanism such as a needle valve as a second flow rate controlling member downstream of the exhaust flow path.

By restricting the flow rate with the flow rate adjusting mechanism in such a configuration, the use efficiency of the fuel can be improved.

Further, the downstream of the exhaust flow path of the fuel cell stack in which the flow rate controlling member is provided so as to be in contact with the anode gas diffusion layer of each of the fuel cell units may be adapted to have no additional flow rate controlling member. Backflow of a gas to each of the fuel cell units can be prevented by the flow rate controlling member provided so as to be in contact with the anode gas diffusion layer, and hence, even if an exhaust port of the fuel cell stack is opened to the atmosphere, for example, the performance of the stack is not affected.

Further features of the present invention will become apparent from the following description of exemplary embodiments with reference to the attached drawings.

### BRIEF DESCRIPTION OF THE DRAWINGS

FIG. 1 is a schematic sectional view illustrating an exemplary configuration of a fuel cell unit according to Embodiment 1 of the present invention.

FIG. 2 is an enlarged schematic view around a flow rate controlling member in the fuel cell unit illustrated in FIG. 1 according to Embodiment 1 of the present invention.

FIG. 3 is a schematic sectional view illustrating an exemplary configuration of a fuel cell stack according to Embodiment 1 of the present invention.

FIG. 4 is an enlarged schematic sectional view around a flow rate controlling member illustrating an exemplary configuration of a fuel cell unit according to Embodiment 2 of the present invention.

FIG. 5 is an enlarged schematic sectional view around a flow rate controlling member illustrating an exemplary configuration of a fuel cell unit according to Embodiment 3 of the present invention.

FIG. 6 is a schematic sectional view illustrating an exemplary configuration of a fuel cell stack according to Embodiment 4 of the present invention.

FIG. 7 is a schematic sectional view illustrating an exemplary configuration of a fuel cell stack according to Embodiment 5 of the present invention.

FIG. 8 is a schematic perspective view illustrating an exemplary configuration of an anode collector according to Example 1 of the present invention.

FIG. 9 is a schematic view illustrating an exemplary configuration of a fuel cell unit of Comparative Example 1.

FIG. 10 is a graph showing the performance of a fuel cell unit according to Example 1 of the present invention.

FIG. 11 is a graph showing the performance of the fuel cell unit of Comparative Example 1.

FIG. 12 is a graph showing the performance of a fuel cell unit according to Example 2 of the present invention.

FIG. 13 is a schematic sectional view illustrating an exemplary configuration of a fuel cell stack according to Example 3 of the present invention.

FIG. 14 is a schematic sectional view illustrating an exemplary configuration of a fuel cell stack according to Example 4 of the present invention.

FIG. 15 is a schematic sectional view illustrating an exemplary configuration of a fuel cell stack of Comparative Example 2.

FIG. 16 is a graph showing the performance of the fuel cell stack according to Example 3 of the present invention.

FIG. 17 is a graph showing the performance of the fuel cell stack according to Example 4 of the present invention.

FIG. 18 is a graph showing the performance of the fuel cell stack of Comparative Example 2.

FIG. 19 is a schematic view illustrating the flow of a fuel of Comparative Example 2.

FIG. 20 is a schematic view illustrating the flow of a fuel according to Example 4 of the present invention.

### BEST MODE FOR CARRYING OUT THE INVENTION

Embodiments of a fuel cell unit and a fuel cell stack according to the present invention are now described in further detail in the following with reference to the drawings. In the fuel cell unit and the fuel cell stack, an anode gas diffusion layer and an anode flow path are provided on a side to which a fuel gas is introduced. An upstream side of the anode flow path to which the fuel gas is introduced is connected to a supply flow path of the fuel gas, and a downstream side of the anode flow path is connected to an exhaust flow path of the fuel gas. The fuel cell unit and the fuel cell stack have a fuel flow path formed of the supply flow path, the anode flow path, and the exhaust flow path.

### Embodiment 1

In this embodiment, an exemplary configuration in which a flow rate controlling member is provided adjacently to a side surface of an anode gas diffusion layer in a fuel flow path of a fuel cell is described.

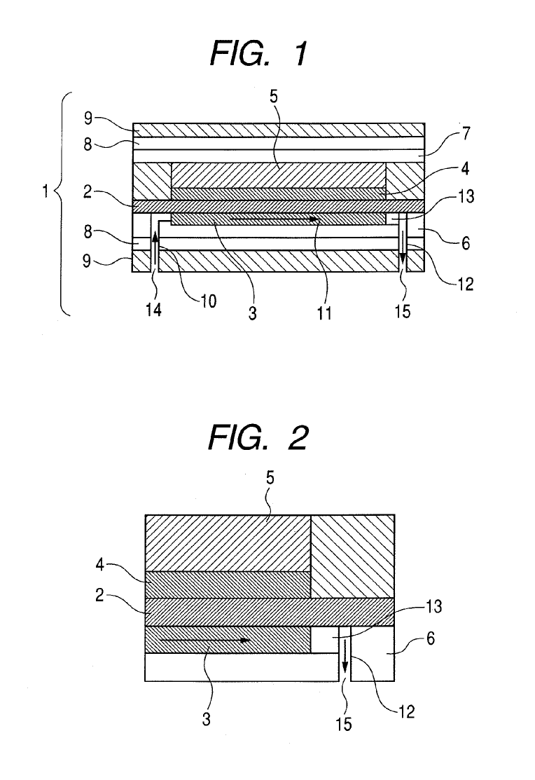

FIG. 1 is a schematic sectional view illustrating an exemplary configuration of a fuel cell unit according to this embodiment.

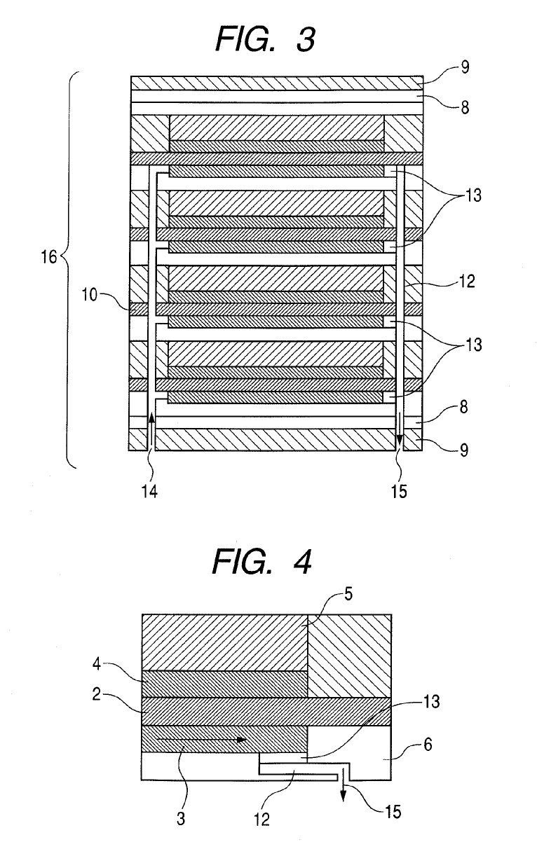

FIG. 2 is an enlarged view around the flow rate controlling member of FIG. 1, and FIG. 3 is a schematic sectional view illustrating a configuration of a fuel cell stack in which a plurality of the fuel cell units according to this embodiment are stacked with each other.

In FIGS. 1 to 3, the fuel cell unit and the fuel cell stack include a fuel cell unit 1, a membrane electrode assembly 2, an anode gas diffusion layer 3, a cathode gas diffusion layer 4, and an oxidant supply layer 5.

The fuel cell unit and the fuel cell stack include an anode collector 6, a cathode collector 7, insulating plates 8, end plates 9, a supply flow path 10, an anode flow path 11, an exhaust flow path 12, a first flow rate controlling member 13, a supply port 14, and an exhaust port 15. FIG. 3 illustrates a fuel cell stack 16. It is to be noted that, in the following drawings, like reference numerals are used to designate like or identical constituting elements.

As illustrated in FIG. 1, the fuel cell unit 1 of Embodiment 1 includes the first flow rate controlling member 13 provided adjacently to a side surface of the anode gas diffusion layer 3 in the anode flow path 11. The membrane electrode assembly 2 is provided in the middle of the fuel cell unit 1 and the anode gas diffusion layer 3 is provided on one surface thereof while the cathode gas diffusion layer 4 is provided on the other surface thereof.

As is well known, the membrane electrode assembly 2 is a polymer electrolyte membrane with an electrode containing a catalyst layer formed on each surface thereof.

As the polymer electrolyte membrane, generally a perfluorosulfonic acid-based proton exchange resin membrane or the like is used, but the present invention can be implemented independently of the kind of the polymer electrolyte membrane.

The catalyst layers formed on both the surfaces of the polymer electrolyte membrane are usually formed of a catalyst which promotes the reaction of the fuel cell and an electrolyte having proton conductivity, and, as necessary, a catalyst carrier, a hydrophobic agent, a hydrophilic agent, or the like is added thereto.

As generally used catalysts, particulates of platinum or a platinum alloy, platinum-carrying carbon, and the like are known, but the present invention can be implemented independently of the kind of those catalysts.

The anode gas diffusion layer 3 and the cathode gas diffusion layer 4 are layers which are permeable to gases and which are electroconductive.

Specifically, the anode gas diffusion layer 3 and the cathode gas diffusion layer 4 have the function of uniformly and sufficiently supplying a fuel and an oxidant to a reaction region of the catalyst in order to efficiently carry out an electrode reaction and taking charges generated by the electrode reaction out of the cell.

Generally, a porous carbon material is used as the gas diffusion layer, and also in the present invention, such a generally used material may be used.

The oxidant supply layer 5 is provided outside the cathode gas diffusion layer 4, and has the functions of supplying an oxidant such as air or oxygen to a surface of the cathode gas diffusion layer 4 and electrically connecting the cathode collector 7 and the cathode gas diffusion layer 4.

Exemplary materials for the oxidant supply layer 5 include a foamed metal, a porous carbon structure, a metal mesh, and a conductive plate having a groove for supplying an oxidant.

In FIG. 1, a fuel cell in which the oxidant supply layer 5 is provided only on a cathode side is illustrated, but the fuel cell may also be configured such that a fuel supply layer having a similar function is provided outside the anode gas diffusion layer 3.

In this embodiment, the anode gas diffusion layer 3 functions both as a gas diffusion layer and as a fuel supply layer.

The anode collector 6 and the cathode collector 7 are plate-like members formed of a conductive material such as a metal or carbon, and have the function of taking out to the external electrons generated by a fuel cell reaction.

Therefore, the anode collector 6 and the cathode collector 7 have terminals provided so as to be in contact with the anode gas diffusion layer 3 and the oxidant supply layer 5, respectively, for taking out the output to the external.

The insulating plate 8 has the function of electrically insulating the end plate 9 and one of the anode collector 6 and the cathode collector 7.

The insulating plate 8 may be formed of, for example, a resin. The end plate 9 has the function of uniformly transferring a clamping pressure to the fuel cell and the fuel cell stack. The end plate 9 may be formed of a rigid material such as steel use stainless (SUS).

In this embodiment, an exemplary configuration is illustrated in which one of the pair of end plates 9 has the supply port 14 and the exhaust port 15 of the fuel gas formed therein, but the present invention is not limited to such a configuration.

In this embodiment, in the fuel flow path formed by the supply flow path 10, the anode flow path 11, and the exhaust flow path 12, the first flow rate controlling member 13 is provided so as to be in contact with the side surface of the anode gas diffusion layer 3 on the side of the exhaust flow path 12 of the anode flow path 11.

The flow rate controlling member 13 has the function of giving a gas flow path resistance to the fuel flow.

Therefore, the fuel supplied from the supply flow path 10 remains in the anode flow path 11 for a long time, which allows the fuel to be uniformly supplied to the anode flow path 11.

As illustrated in FIG. 3, in the fuel cell stack 16 formed by stacking a plurality of the fuel cell units each including the flow rate controlling member 13 described above, even if the flow path resistances of the respective fuel cell units vary among the fuel cell units, the fuel can be supplied uniformly to the respective fuel cell units.

Further, the flow rate controlling member 13 has the function of preventing backflow of the fuel gas containing an impurity gas which exists in the exhaust flow path 12 of the fuel cell unit and the fuel cell stack (the fuel gas containing air in the atmosphere which flows back from the exhaust port 15) into the anode flow path 11.

The backflow is most likely to occur immediately after the beginning of the electric power generation by the fuel cell.

When the electric power generation begins, the fuel gas filling the anode flow path 11 is consumed, and hence the pressure of the fuel gas in the anode flow path 11 drops and the fuel gas flows back from downstream of the anode flow path 11 including the exhaust flow path 12.

As the concentration of the impurity gas contained in the fuel gas which flows back becomes higher, the effect on the performance of the fuel cell becomes greater.

The amount of the pressure drop in the anode flow path 11 depends on the amount of the consumed fuel gas, and as more electric power is generated, the pressure drops more.

By providing the flow rate controlling member on the side of the exhaust flow path in the fuel flow path in order to prevent the above-mentioned backflow of the fuel gas containing the impurity gas, backflow into the anode flow path 11 can be prevented.

The lower limit value of the flow path resistance of the flow rate controlling member in order to prevent the backflow into the anode flow path 11 is determined by the magnitude of the pressure loss in the anode flow path 11 caused by the electric power generation. The pressure difference of the fuel gas created by the flow rate controlling member when electric power is not generated is characterized by being at least larger than the pressure loss caused by the electric power generation in the anode flow path.

The design is preferably performed on the assumption that the highest amount of current which can be generated by the fuel cell is generated here.

By designing the pressure difference generated by the flow rate controlling member in this way, even immediately after the beginning of the electric power generation by the fuel cell when the backflow is most likely to occur, the backflow into the anode flow path 11 can be prevented.

Further, the flow rate controlling member 13 has the function of, when the fuel cell stack 16 illustrated in FIG. 3 is formed, preventing backflow of the fuel gas containing the impurity gas from the exhaust flow path 12 into the anode flow path 11 of a specific fuel cell unit.

Meanwhile, the flow rate controlling member 13 also has the function of exhausting an impurity gas such as nitrogen, carbon dioxide, or water vapor which enters the anode flow path 11 to the exhaust flow path 12.

The impurity gas which enters the anode flow path 11 mainly passes through the membrane electrode assembly 2 and then enters the anode flow path 11.

While the speed of the impurity gas which passes through the membrane electrode assembly 2 considerably varies depending on the kind of the polymer electrolyte membrane, the temperature, the humidity, the partial pressure, and the like, the impurity gas which enters the anode flow path 11 affects the performance of the fuel cell, and thus, the impurity gas is necessary to be promptly exhausted to the exhaust flow path 12.

Therefore, the flow rate controlled by the first flow rate controlling member which is the flow rate controlling member 13 is preferably set to be at least higher than the flow rate of the impurity gas including nitrogen which enters the anode flow path 11.

More specifically, the upper limit value of the flow path resistance by the flow rate controlling member is determined by the flow rate of the impurity gas which enters. By designing in this way, the fuel cell unit 1 can generate electric power stably without convection of the impurity gas in the anode flow path 11.

Although, in FIG. 2, formed over the whole region to the exhaust flow path 12, the flow rate controlling member 13 may be formed in only a part of the region to the exhaust flow path 12 as long as the flow rate controlling member 13 performs the above-mentioned functions.

The flow rate controlling member 13 is provided adjacently to the side surface of the anode gas diffusion layer 3, and hence the stability of the electric power generation by the fuel cell unit 1 can be enhanced.

If the flow rate controlling member 13 is provided away from the anode gas diffusion layer 3, there is a risk that the flow path is clogged by condensation of water upstream of the flow rate controlling member 13.

As a result, exhaust of the impurity gas from the anode flow path 11 is interrupted, and thus, the performance of the fuel cell is lowered.

By providing the flow rate controlling member 13 adjacently to the side surface of the anode gas diffusion layer 3, the temperature conditions of the flow rate controlling member 13 are substantially the same as those of an electric power generating portion of the fuel cell, and thus, condensation is less likely to occur.

At the same time, the flow rate controlling member 13 is adjacent to the side surface of the anode gas diffusion layer 3, and hence the flow path is not completely clogged, and thus, the flow through the flow rate controlling member 13 can be maintained.

In this embodiment, the flow rate controlling member 13 may be formed of, for example, a porous body.

The porous body may be any kind of porous body as long as the flow path resistance (flow rate control) can be realized in the above-mentioned range.

Parameters which define the flow path resistance such as the size of the flow rate controlling member 13 and the aperture ratio and aperture diameter of the member which forms the flow rate controlling member 13 should be set according to the required flow path resistance in the above-mentioned range.

As the porous body used as the flow rate controlling member 13, because of the chemically and mechanically high stability or the like, a porous PTFE filter or the like may be used.

Further, the porous body may also be formed by mixing particulates and a binder. The pore diameter, the pore distribution, and the like of a porous body formed by mixing particulates and a binder can be controlled by the size of the particulates, the dispersion concentration, or the like, and hence desired flow path resistance can be realized.

Exemplary binders include a PTFE dispersion owing to chemically high stability thereof. As the particulates, chemically highly stable particulates such as carbon, platinum-carrying carbon, and platinum black, or functional particulates such as a hydrogen storage material may be used.

For example, by using platinum-carrying carbon or platinum black as the particulates, the flow rate controlling member 13 is made to function as a catalyst, and, in addition to the function as the flow rate controlling member, the function as a combustion device for discharging the fuel to the outside air with safety can be given to the flow rate controlling member 13.

Alternatively, by using functional particulates such as a hydrogen storage material, the flow path resistance of the flow rate controlling member can be controlled while utilizing volume change of the gas when brought into contact with hydrogen or when brought into contact with moisture.

### Embodiment 2

In Embodiment 2, unlike the configuration of Embodiment 1 in which the flow rate controlling member 13 is provided adjacently to the side surface of the anode gas diffusion layer 3, an exemplary configuration in which the flow rate controlling member 13 is provided so as to be in contact with a rear surface of the anode gas diffusion layer 3 is described.

FIG. 4 is an enlarged schematic sectional view around a flow rate controlling member illustrating an exemplary configuration of a fuel cell unit according to this embodiment.

As illustrated in FIG. 4, the configuration of the fuel cell unit is the same as that in Embodiment 1 except for the position of the flow rate controlling member 13.

It is enough that at least a part of the flow rate controlling member 13 is held in contact with the anode gas diffusion layer 3 in the anode flow path 11 and is provided on the side of the exhaust flow path 12.

In this embodiment, as illustrated in FIG. 4, the flow rate controlling member 13 is adapted to be provided on the rear surface of the anode gas diffusion layer 3.

This allows use of a sheet-like or film-like material as the flow rate controlling member 13, and thus, a wide choice of materials to be used as the flow rate controlling member 13 is offered.

For example, a PTFE filter, a hydrophilic PTFE filter, or a cellulose mixed ester filter may be used.

Further, the degree of flexibility of the shape of the cell or the shape of the flow path becomes higher, and hence miniaturization of the fuel cell and simplification of the manufacturing process become possible.

### Embodiment 3

In Embodiment 3, an exemplary configuration in which the flow rate controlling member 13 of Embodiment 1 is formed by altering a part of the anode gas diffusion layer 3 on the downstream side of the anode flow path is described.

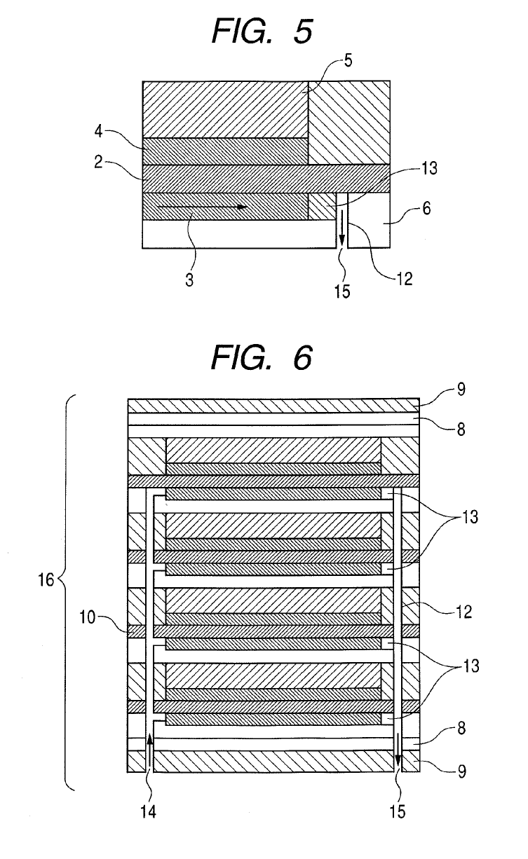

FIG. 5 is an enlarged schematic sectional view around a flow rate controlling member illustrating the exemplary configuration of a fuel cell unit according to this embodiment.

As described above, the configuration of the fuel cell unit of this embodiment is the same as that illustrated in Embodiment 1 except that a part of the anode gas diffusion layer 3 is altered.

Although, in Embodiments 1 and 2, the flow rate controlling member 13 is formed of a member provided separately from the anode gas diffusion layer 3, this embodiment is characterized in that a part of the anode gas diffusion layer 3 is configured to form the flow rate controlling member 13.

By making lower on the downstream side of the fuel flow path the permeability to gases of the anode gas diffusion layer 3 which is highly permeable to gases, the above-mentioned configuration can be attained.

Exemplary means for lowering the permeability to gases of the anode gas diffusion layer 3 include means for compressing the gas diffusion layer, means for filling the gas diffusion layer with a filler or the like, and means for using both the filling means and the compressing means.

### Embodiment 4

In Embodiment 4, an exemplary configuration of a fuel cell stack in which multiple fuel cell units including the flow rate controlling members 13 illustrated in Embodiments 1 to 3 are stacked is described.

FIG. 6 is a schematic sectional view illustrating the exemplary configuration of a fuel cell stack according to this embodiment.

In this embodiment, an additional flow rate controlling member is not necessary provided downstream of the exhaust port 15 of the fuel cell stack 16 which has the flow rate controlling members 13.

The flow rate controlling members 13 provided for the respective anode flow paths 11 can prevent backflow from the exhaust flow path 12, and hence the exhaust port 15 may be, for example, opened to the atmosphere.

From the viewpoint of the use efficiency and the safety of the supplied fuel, the configuration is preferably adopted in which the flow rate controlling members 13 considerably restrict the flow rate of the fuel.

In order to make higher the degree of flexibility of the position in incorporation into electronic equipment, a fuel diluter or a catalyst such as platinum may be provided downstream of the exhaust port, and a mechanism may be provided for consuming the fuel by using a member such as a combustion device for gradually reacting the fuel included in the exhausted gas with oxygen in the atmosphere.

### Embodiment 5

In Embodiment 5, an exemplary configuration is described in which a flow rate adjusting mechanism which is a second flow rate controlling member is provided downstream of the exhaust port 15 of the fuel cell stack 16 having multiple fuel cell units which include the flow rate controlling members 13 illustrated in Embodiments 1 to 3 stacked therein.

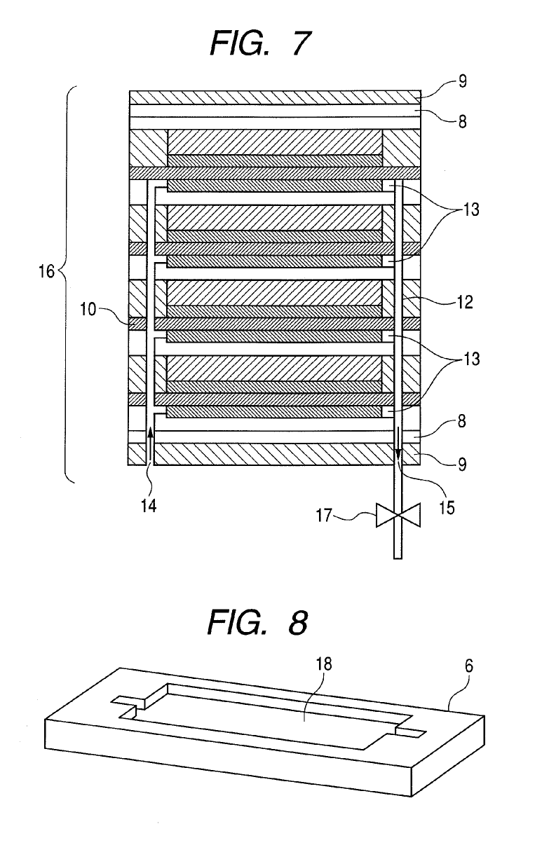

FIG. 7 is a schematic sectional view illustrating the exemplary configuration of a fuel cell stack according to this embodiment.

A flow rate adjusting mechanism 17 such as a needle valve as the second flow rate controlling member is provided downstream of the exhaust port 15 of the fuel cell stack 16 having the flow rate controlling members 13.

The flow rate adjusting mechanism 17 has the function of suppressing the exhaust amount of the fuel gas which is exhausted from the fuel cell stack 16 and which contains an impurity gas.

The flow rate adjusting mechanism 17 is, for example, formed as a control valve for controlling the exhaust amount of the fuel gas which contains an impurity gas.

The flow rate of the gas which passes through the flow rate adjusting mechanism 17 is determined according to the amount of the impurity gas which passes through the membrane electrode assembly 2 and enters the anode flow path 11.

Such a configuration makes it possible to increase the use efficiency of the fuel supplied to the fuel cell stack 16 and still prevent accumulation of the impurity gas.

Further, a mechanism for consuming the fuel gas may be provided downstream of the flow rate adjusting mechanism 17 using the above-mentioned mechanism such as a fuel diluter and a combustion device.

By providing the flow rate adjusting mechanism 17 between the exhaust port 15 and the mechanism for consuming the fuel gas, the flow rate of the fuel is controlled according to the processing ability of the mechanism for consuming the fuel gas.

According to the embodiments of the present invention described above, by the first flow rate controlling member described above, large pressure difference can be generated between an upstream side of the fuel flow path from a portion at which the first flow rate controlling member is provided and a downstream side of the fuel flow path from the portion at which the first flow rate controlling member is provided.

This allows uniform supply of a fuel from the supply flow path to the anode flow path including an electric power generating portion of the fuel cell, and backflow of the fuel gas containing the impurity gas from the exhaust flow path can be prevented.

Further, by providing the flow rate controlling member so as to be in contact with the anode gas diffusion layer, clogging of the flow path due to condensation of moisture generated in association with the electric power generating reaction of the fuel cell and diffused in the anode flow path can be prevented.

Clogging of the flow path between the anode flow path and the flow rate controlling member inhibits exhaust of the impurity gas which enters the anode flow path, and thus, reduces the performance of the fuel cell.

Providing the flow rate controlling member so as to be in contact with the anode gas diffusion layer allows the flow rate controlling member to be placed under temperature conditions which are equivalent to or near to those of the electric power generating portion, and thus, condensation can be prevented. As a result, the fuel cell can be driven stably.

With such a configuration, even in a dead-end fuel cell and in a system in which the flow rate of a fuel is tightly restricted downstream of the fuel flow path of the fuel cell stack, the fuel is uniformly supplied to the respective fuel cell units of the fuel cell and the fuel cell stack, and backflow and accumulation of the impurity gas from the downstream side can be prevented.

Further, the flow path between the anode flow path and the first flow rate controlling member is not clogged by condensation, and hence the fuel cell can be driven stably.

Further, the fuel cell stack in which the first flow rate controlling member is provided so as to be in contact with the anode gas diffusion layer of each of the fuel cell units may be adapted to have a flow rate adjusting mechanism such as a needle valve as a second flow rate controlling member downstream of the exhaust flow path as described in Embodiment 5.

By restricting the flow rate with the flow rate adjusting mechanism in such a configuration, the use efficiency of the fuel can be improved.

Further, the downstream of the exhaust flow path of the fuel cell stack in which the flow rate controlling member is provided so as to be in contact with the anode gas diffusion layer of each of the fuel cell units may be adapted to have no additional flow rate controlling member. Backflow of a gas to each of the fuel cell units can be suppressed by the flow rate controlling member provided so as to be in contact with the anode gas diffusion layer, and hence, even if an exhaust port of the fuel cell stack is opened to the atmosphere, for example, the effect on the stack performance can be made small.

Examples of the present invention are described in the following.

### Example 1

In Example 1, an exemplary configuration of a fuel cell in which a PTFE filter used as the flow rate controlling member 13 illustrated in FIG. 1 is provided so as to be in contact with the anode gas diffusion layer is described.

In this example, a membrane electrode assembly prepared as follows was used.

As the polymer electrolyte membrane, a Nafion (registered trademark) membrane (NRE-212CS manufactured by DuPont) was used.

As the catalyst layer, a catalyst layer containing a platinum dendritic structure obtained by appropriate reduction treatment of a dendritic structure formed of a platinum oxide was used.

As a base material for forming the dendritic structure formed of a platinum oxide, a PTFE sheet (Nitofron (registered trademark) manufactured by NITTO DENKO CORPORATION) was used, and the dendritic structure formed of a platinum oxide which is a catalyst precursor was formed thereon at a thickness of 2 μm by reactive sputtering.

The amount of the carried Pt in this case was 0.68 Mg/cm².

It is to be noted that the amount of the carried Pt was detected by X-ray fluorescence spectrometry. Reactive sputtering was carried out with the total pressure being 4 Pa, the oxygen flow rate ratio (QO₂/(QAr+QO₂)) being 70%, the substrate temperature being 25° C., and the applied power being 4.9 W/cm².

After appropriate hydrophobic treatment had been carried out with respect to the obtained dendritic structure formed of a platinum oxide, a proton conductive electrolyte was applied thereon.

The proton conductive electrolyte was a five-fold dilution of a 5 wt % Nafion (registered trademark) (manufactured by Wako Pure Chemical Industries, Ltd.) solution diluted with isopropyl alcohol (reagent, manufactured by Wako Pure Chemical Industries, Ltd.). After applying the proton conductive electrolyte at a rate of 10 μl/cm², a solvent was volatilized to form the catalyst layer.

The obtained catalyst layer was cut out, and hot pressing was carried out with the catalyst layer being provided on both surfaces of the polymer electrolyte membrane (at 4 MPa and at 150° C. for 30 minutes) to obtain the membrane electrode assembly.

It is to be noted that the effective area of the polymer electrolyte membrane was adapted to be 2 cm². Carbon cloth (manufactured by E-TEK Inc. with the anode being LT2500-W and the cathode being LT1200-W) was used as the anode gas diffusion layer and the cathode gas diffusion layer, and a foamed metal (CELMET #5 manufactured by Sumitomo Electric Industries, Ltd.) was used as the oxidant supply layer.

A processed SUS plate was used as the anode and cathode collectors. A processed SUS plate with gold plating thereon for decreasing the contact resistance applied on a surface thereof was used.

FIG. 8 is a perspective view illustrating a configuration of the anode collector according to this example.

A recess 18 at a depth corresponding to the thickness of the anode gas diffusion layer 3 was dug in the anode collector 6. The anode flow path 11 was adapted to be filled with the anode gas diffusion layer 3.

In this configuration, the anode gas diffusion layer functions as the anode flow path. The flow rate of hydrogen in the anode flow path 11 filled with the anode gas diffusion layer 3 was 0.5 ml/sec when hydrogen was supplied at a pressure of 0.1 MPa (gage pressure, hereinafter the same applies). As the flow rate controlling member 13, a porous PTFE sheet (MD5843 manufactured by Donaldson Company, Inc. with the pore size being 0.35 μm) was used.

As illustrated in FIG. 1, the flow rate controlling member 13 which was a porous PTFE sheet was provided adjacently to the side surface on the downstream side of the anode gas diffusion layer 3, and the flow rate of hydrogen was adjusted to be 0.1 ml/sec when hydrogen was supplied at a pressure of 0.1 MPa.

In this case, after the above-mentioned adjustment, the flow rate of N₂ which passes through the polymer electrolyte membrane (NRE-212CS) having the effective area of 2 cm² at 40° C. when the both surfaces are humidified (90% R.H.) was 2.3×10⁻⁵ ml/sec·atm.

From the above, it can be seen that a flow rate which was sufficient to exhaust the impurity gas which entered the anode flow path 11 was secured.

Further, the relationship with the pressure loss was also reviewed. When electric power was generated at a constant current of 350 mA/cm², the pressure loss due to consumption of the fuel was 11 kPa.

On the other hand, the pressure loss due to the flow rate controlling member 13 which was a porous PTFE sheet was 21 kPa. It was confirmed that the pressure difference of the fuel gas generated by the flow rate controlling member 13 was larger than the pressure loss caused by the electric power generation.

The above-mentioned members were used to manufacture the fuel cell illustrated in FIG. 1, and the fuel cell characteristics were evaluated.

The evaluation was made with a constant current of 350 mA/cm² at a temperature of 25° C. with the relative humidity being 50% when pure hydrogen without adding humidity thereto was supplied to the anode at a pressure of 0.1 MPa while a fixed amount of airflow was supplied to the cathode.

The result of the evaluation of the fuel cell characteristics of this example is illustrated in FIG. 10. The result was compared with that of Comparative Example 1 as follows.

### Comparative Example 1

In Comparative Example 1, in order to make a comparison with the fuel cell unit in which the flow rate controlling member 13 was provided so as to be in contact with the anode gas diffusion layer 3 as in Example 1, a fuel cell unit in which the flow rate controlling member 13 was spaced from the anode gas diffusion layer 3 was manufactured.

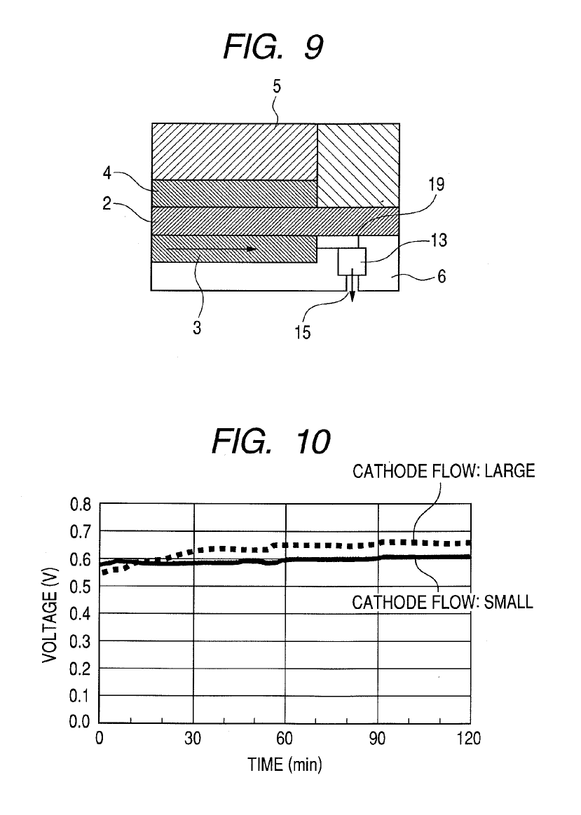

More specifically, in this comparative example, as illustrated in FIG. 9, the flow rate controlling member 13 was provided so as not to be in contact with the side surface of the anode gas diffusion layer 3 such that space 19 existed therebetween.

In this case, except for the position of the flow rate controlling member 13, the configuration was the same as that of Example 1.

The fuel cell characteristics were evaluated under the same conditions as those of Example 1.

The result of the evaluation of the fuel cell characteristics of this comparative example is illustrated in FIG. 11.

With regard to the fuel cell of Comparative Example 1, as illustrated in FIG. 11, it was observed that, when the cathode flow rate is low, the performance of the cell was unstable.

When the cathode flow rate was high, water generated by a fuel cell reaction was removed by the cathode flow, and hence the amount of water which diffused back to the anode chamber through the membrane electrode assembly was small.

On the other hand, when the cathode flow rate was low, the amount of generated water which remains on the side of the cathode was large, and hence the amount of water which diffused back to the anode chamber was large.

When the amount of water which diffused back to the anode chamber was large, condensation occurs in the space 19 between the anode gas diffusion layer 3 and the flow rate controlling member 13, and thus, the fuel flow path is clogged.

As a result, the impurity gas gradually accumulated to drop the partial pressure of hydrogen in the anode chamber, which probably affected the performance of the cell.

On the other hand, in Example 1 in which the flow rate controlling member 13 was provided adjacently to the anode gas diffusion layer 3, as illustrated in FIG. 10, it was observed that the performance of the cell was stable.

This is probably because, in Example 1, even when the amount of water which diffused back to the anode chamber was large, clogging of the flow path due to condensation was suppressed between the anode gas diffusion layer and the flow rate controlling member.

As a result, in Example 1, accumulation of the impurity gas in the anode flow path could be suppressed, and thus, the fuel cell could be driven more stably.

### Example 2

In Example 2, in order to make a comparison with the fuel cell unit in which a PTFE filter was used as the flow rate controlling member 13 as in Example 1, an exemplary configuration of a fuel cell unit in which a porous body which is formed of particulates and a binder was used as the flow rate controlling member 13 is described.

More specifically, in this example, the position denoted as the flow rate controlling member 13 in FIG. 2 was filled with the porous body manufactured as described below. In this case, except for the flow rate controlling member 13, the configuration was the same as that of Example 1.

As the particulates, LaNi₅ powder the diameter of which was uniformly made to be 75 μm was used, and, as the binder, a PTFE dispersion (D-1E manufactured by DAIKIN INDUSTRIES, Ltd.) was used.

After adjustment was made to the PTFE dispersion such that the ratio by weight of the PTFE to the LaNi5 powder was 10 wt %, the LaNi₅ powder was put into an agate mortar, and the PTFE dispersion was added thereto while being mixed with a pestle.

In this case, for the sake of easiness of the mixing, a large amount of ethanol was added. Kneading was carried out to obtain a gum-like substance. The substance was then air-dried to evaporate ethanol. The obtained paste was squeezed into the place in which the flow rate controlling member 13 was to be provided in the flow path of the electrode plate.

When hydrogen was supplied at a pressure of 0.1 MPa, the flow rate of hydrogen was about 3.3×10⁻³ ml/sec.

The fuel cell unit was manufactured under the same conditions as those of Example 1 except that the porous body formed of the particulates and the binder was used as the flow rate controlling member 13.

Evaluation was made at a temperature of 25° C. with the relative humidity being 50% when pure hydrogen without adding humidity thereto was supplied to the anode at a pressure of 0.1 MPa, and the exhaust port 15 was opened to the atmosphere.

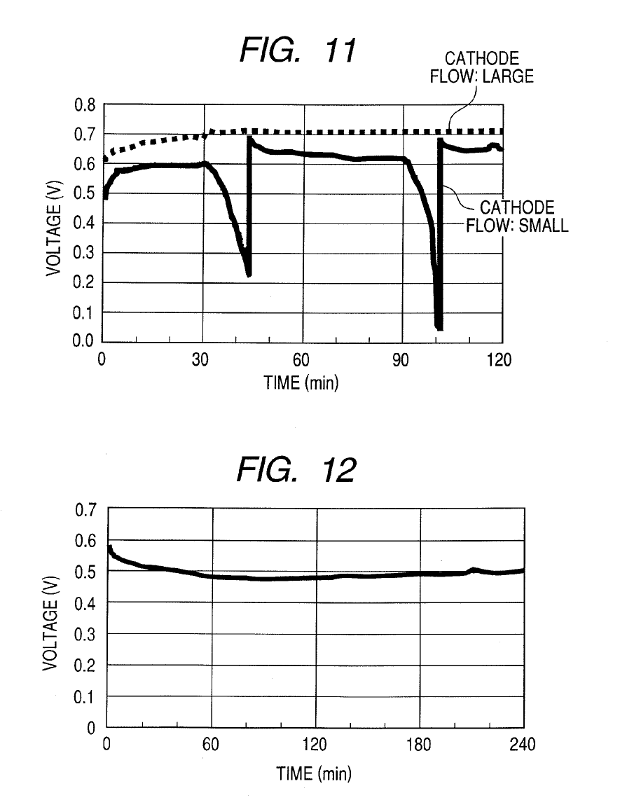

An air-breathing system was adopted in which air was supplied to the cathode by natural aspiration, and a measurement was made with a constant current of 350 mA/cm². The result of the evaluation of the fuel cell characteristics of this example is illustrated in FIG. 12.

It can be seen that, because, similarly to the case of Example 1, the flow rate controlling member 13 is provided so as to be in contact with the anode gas diffusion layer 3, even when electric power is generated for a long time, the voltage value is stable. When air is supplied by natural aspiration, it is very likely that generated water remains on the side of the cathode, and the amount of water which diffuses back to the side of the anode is large, but it can be seen that the fuel was supplied stably without clogging of the anode flow path.

Further, even when the exhaust port 15 was opened to the atmosphere, air did not flow back into the anode flow path to adversely affect the performance.

Even with the porous body formed of the particulates and the binder, the flow rate could be controlled to a desired amount, and, similarly to the case of Example 1, stability in driving for a long time could be realized.

### Example 3

In Example 3, an exemplary configuration of a fuel cell stack in which four fuel cells of Example 1 are stacked is described.

The configuration of each of the fuel cell units was the same as that described in Example 1.

When the four fuel cells were stacked, electrical connection between the fuel cell units was made through an intermediation of a bipolar plate 24 in which an anode collector and a cathode collector were integrated.

The fuel flow path was structured such that the fuel was provided from the supply flow path 10 to the anode flow paths 11 of the respective fuel cell units in parallel, and was connected to the exhaust flow path 12.

The flow rate controlling member 13 was adjusted such that the flow rate of hydrogen was, when hydrogen was supplied at a pressure of 0.1 MPa, 0.1 ml/sec as a whole in the stack.

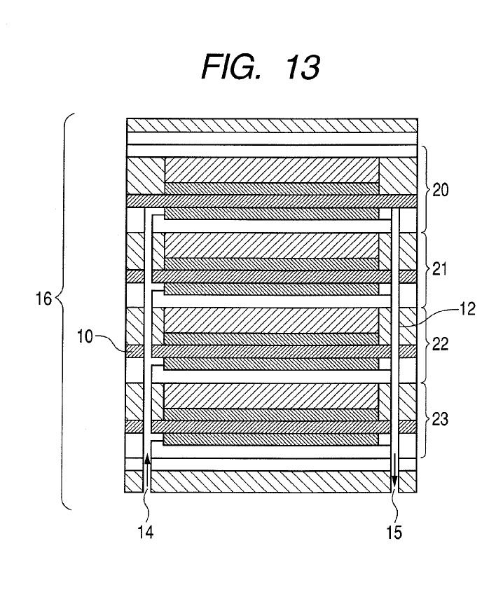

FIG. 13 illustrates a configuration of the fuel cell stack of this example. The exhaust port 15 was opened to the atmosphere, and, similarly to the case of Example 1, the fuel cell stack characteristics were evaluated. It is to be noted that, throughout the figures, reference numerals 20, 21, 22, and 23 denote Cells 1, 2, 3, and 4, respectively. The same applies in the subsequent figures.

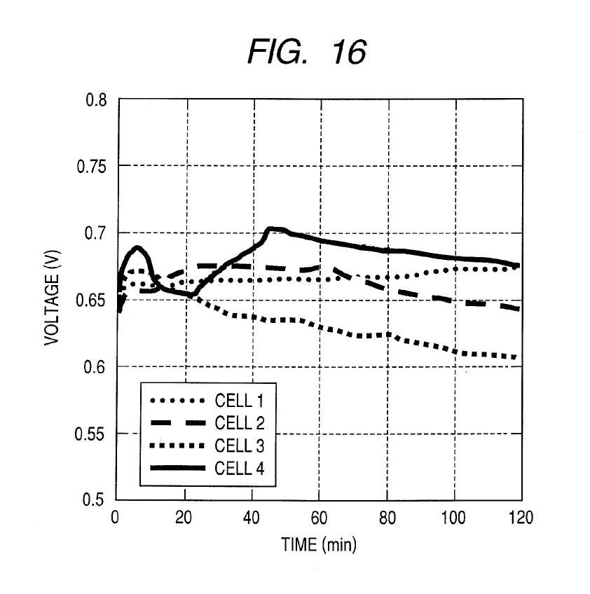

The result of the evaluation of the fuel cell stack characteristics is illustrated in FIG. 16. The result was compared with that of Comparative Example 2 as follows.

### Example 4

In Example 4, an exemplary configuration of a fuel cell stack in which a needle valve as the flow rate adjusting mechanism 17 which was a second flow rate controlling member was provided on the downstream side of the fuel flow path in the fuel cell stack of Example 3 is described.

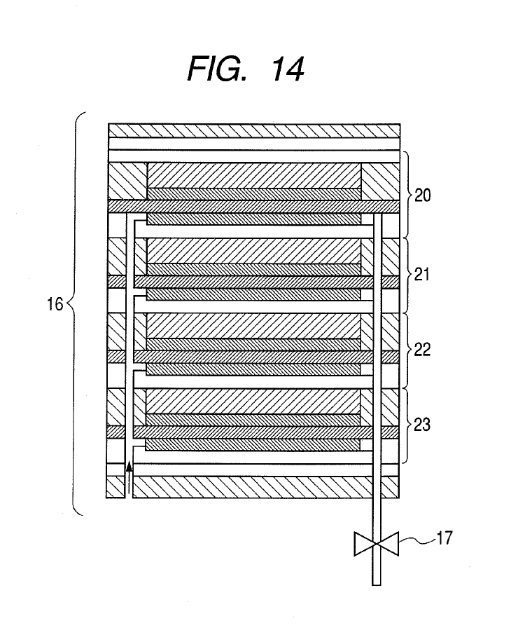

FIG. 14 is a schematic sectional view illustrating the exemplary configuration of a fuel cell stack according to this example. A stack similar to as that of Example 3 was manufactured, and further, a needle valve was provided downstream of the exhaust port 15. Adjustment was made such that the flow rate of hydrogen was, when hydrogen was supplied at a pressure of 0.1 MPa, 0.05 ml/sec as a whole in the stack.

Similarly to the case of Example 1, the fuel cell stack characteristics were evaluated.

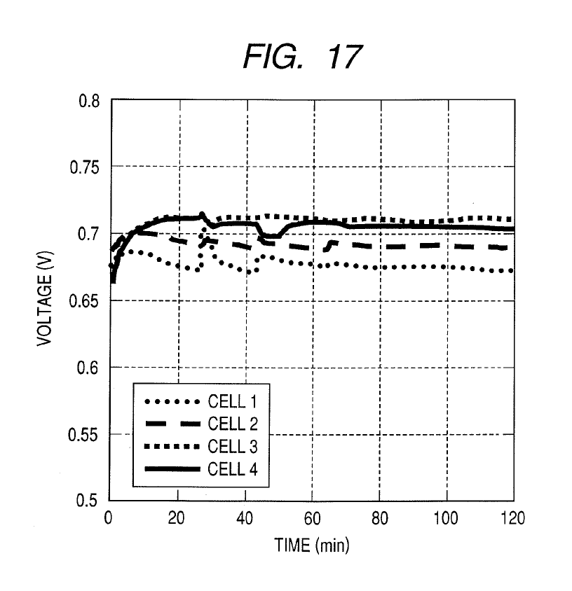

The result of the evaluation of the fuel cell stack characteristics is illustrated in FIG. 17. The result was compared with that of Comparative Example 2 as follows.

### Comparative Example 2

While, in the fuel cell stack of Example 4, the flow rate controlling members 13 were provided, in this comparative example, a fuel cell stack in which the anode flow paths of the respective fuel cell units did not have the flow rate controlling members 13 provided therein was manufactured.

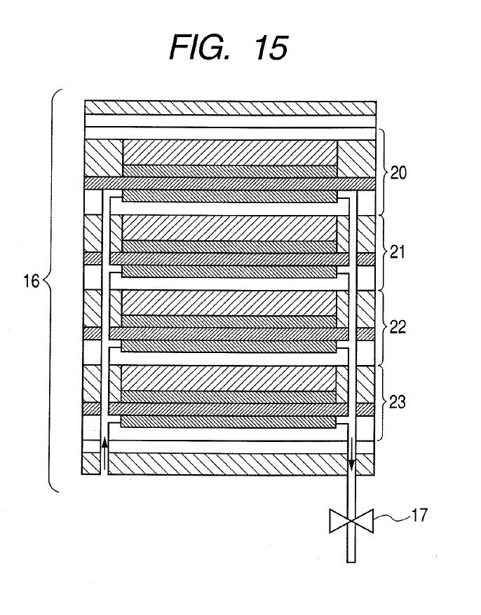

FIG. 15 illustrates the fuel cell stack of this comparative example.

The configuration of the fuel cell stack was the same as that illustrated in Example 4 except that the flow rate controlling members 13 were not provided.

A needle valve as the flow rate adjusting mechanism 17 which was a second flow rate controlling member was provided, and adjustment was made such that the flow rate of hydrogen was, when hydrogen was supplied at a pressure of 0.1 MPa, 0.05 ml/sec as a whole in the stack. Similarly to the case of Example 1, the fuel cell stack characteristics were evaluated.

The result of the evaluation of the fuel cell stack characteristics of this comparative example is illustrated in FIG. 16.

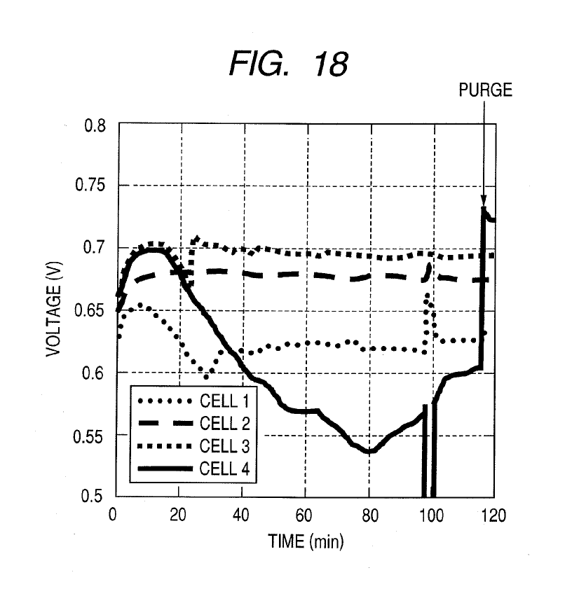

Next, a comparison was made therebetween with reference to FIG. 16 illustrating the result of the evaluation of this comparative example and FIGS. 17 and 18 illustrating the result of the evaluation of the above-mentioned Examples 3 and 4.

In the figures, the fuel cell units in the respective fuel cell stacks were referred to as Cells 1 to 4 from the top to the bottom.

FIGS. 16, 17, and 18 illustrate voltage behavior of the respective fuel cell units of the fuel cell stacks.

In the result of the evaluation of the fuel cell stack of Comparative Example 2 (FIG. 18), it was observed that the performance of a specific fuel cell unit (Cell 4) was lowered.

The result of measurements of the impedance confirmed that the cause of the lowered performance was not flooding on the side of the cathode or dryout of the polymer electrolyte membrane.

Before the continuous drive time reaches 120 minutes, the needle valve was temporarily released to purge the gas in the anode flow paths. The restoration of performance was observed with regard to Cell 4 and Cell 1.

From the result, the lowered performance of the specific fuel cell unit of the fuel cell stack of Comparative Example 2 was probably lowered performance due to accumulation of an impurity gas in the anode flow paths.

The deterioration of performance was not observed with regard to Cell 2 and Cell 3, and hence a part of the fuel gas containing an impurity gas of the respective fuel cell units probably has flowed back into and accumulated in the specific fuel cell unit (Cell 4) without being exhausted to the external through the needle valve.

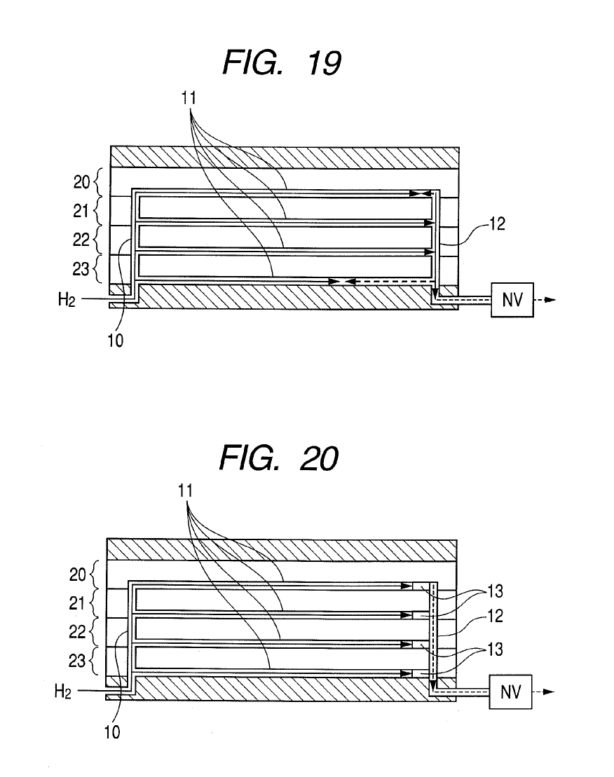

FIG. 19 is a schematic view illustrating the fuel flow in the fuel cell stack of Comparative Example 2.

The restoration of performance as a result of the temporary release of the needle valve was observed, it is assumed that a nonuniform fuel flow as illustrated in FIG. 19 was generated. One cause of such a nonuniform fuel flow is variation in flow path resistance among the anode flow paths of the respective stacked fuel cell units.

On the other hand, in Examples 3 and 4 which are fuel cell stacks having the flow rate controlling members 13 in the anode flow paths of the respective fuel cell units, as illustrated in FIGS. 16 and 17, lowered performance due to accumulation of an impurity gas in the anode flow paths was not observed.

This is probably because the flow rate controlling members 13 were provided, the fuel was uniformly supplied to the respective fuel cell units of the fuel cell stacks, and backflow of the fuel gas including an impurity gas and the atmosphere from the exhaust flow path 12 was suppressed.

FIG. 20 is a schematic view illustrating the fuel flow in the fuel cell stack of Example 4.

The flow rate controlling members 13 in Example 3 and Example 4 are adapted to be able to generate a very large pressure difference, and hence the fuel can be uniformly supplied to the respective fuel cell units upstream of the flow rate controlling members.

At the same time, backflow from the exhaust flow path 12 can be suppressed, and the performance of a specific fuel cell unit in the fuel cell stacks can be prevented from being lowered or being unstable.

Further, the flow rate controlling members 13 are provided so as to be in contact with the anode gas diffusion layers 3, and hence the adverse effect of condensed water on the performance can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-016455, filed Jan. 28, 2008, which is hereby incorporated by reference in its entirety.

1. A fuel cell unit, comprising:
an anode gas diffusion layer and an anode flow path on a side to which a fuel gas is introduced;
a supply flow path having a supply port of the fuel gas, the supply flow path being connected upstream of the anode flow path to which the fuel gas is introduced;
an exhaust flow path having an exhaust port of the fuel gas, the exhaust flow path being connected downstream of the anode flow path to which the fuel gas is introduced, the supply flow path, the anode flow path, and the exhaust flow path forming a fuel flow path; and
a first flow rate controlling member provided in the fuel flow path on a side of the exhaust flow path to be in contact with the anode gas diffusion layer,
wherein, by the first flow rate controlling member, pressure difference is generated between an upstream side of the fuel flow path from a portion at which the first flow rate controlling member is provided and a downstream side of the fuel flow path from the portion at which the first flow rate controlling member is provided.

2. The fuel cell unit according to claim 1, wherein a flow rate controlled by the first flow rate controlling member is larger than an entry flow rate of an impurity gas containing nitrogen which enters the anode flow path.

3. The fuel cell unit according to claim 1, wherein, when electric power is not generated, the pressure difference of the fuel gas generated by the first flow rate controlling member is larger than a pressure loss caused by electric power generation in the anode flow path.

4. The fuel cell unit according to claim 1, wherein the first flow rate controlling member is formed of a part of the anode gas diffusion layer.

5. The fuel cell unit according to claim 1, wherein the first flow rate controlling member comprises a porous body.

6. The fuel cell unit according to claim 1, wherein the anode flow path is filled with the anode gas diffusion layer.

7. The fuel cell unit according to claim 1, further comprising a second flow rate controlling member provided downstream of the exhaust port, for suppressing an exhaust amount of the fuel gas exhausted from the exhaust port.

8. The fuel cell unit according to claim 1, further comprising a fuel gas consuming mechanism provided downstream of the exhaust port, for consuming the fuel gas exhausted from the exhaust port.

9. The fuel cell unit according to claim 8, further comprising a second flow rate controlling member provided between the exhaust port and the fuel gas consuming mechanism, for suppressing an exhaust amount of the fuel gas exhausted from the exhaust port.

10. A fuel cell stack, comprising:
a plurality of the fuel cell units according to claim 1 stacked with each other;
a supply flow path having a supply port of a fuel gas, the supply flow path being connected upstream of an anode flow path of each of the fuel cell units, to which the fuel gas is introduced; and
an exhaust flow path having an exhaust port of the fuel gas, the exhaust flow path being connected downstream of the anode flow path of each of the fuel cell units, to which the fuel gas is introduced, the supply flow path, the anode flow path, and the exhaust flow path forming a fuel flow path.

11. The fuel cell stack according to claim 10, further comprising a second flow rate controlling member provided downstream of the exhaust port, for suppressing an exhaust amount of the fuel gas exhausted from the exhaust port.

12. The fuel cell stack according to claim 10, further comprising a fuel gas consuming mechanism provided downstream of the exhaust port, for consuming the fuel gas exhausted from the exhaust port.

13. The fuel cell stack according to claim 12, further comprising a second flow rate controlling member provided between the exhaust port and the fuel gas consuming mechanism, for suppressing an exhaust amount of the fuel gas exhausted from the exhaust port.
